(19) United States
(12) Patent Application Publication
(10) Pub. No.: US 2012/0106516 A1
(43) Pub. Date: May 3, 2012

(54) METHOD AND APPARATUS FOR TRANSMITTING NEIGHBOR BASE STATION INFORMATION PERFORMED BY MACRO BASE STATION IN WIRELESS COMMUNICATION SYSTEM

(75) Inventors: Soojung Jung, Daejeon (KR); Juhee Kim, Daejeon (KR); Eunkyung Kim, Daejeon (KR); Jae Sun Cha, Daejeon (KR); Kwang Jae Lim, Daejeon (KR); Hyun Lee, Daejeon (KR); Chul Sik Yoon, Seoul (KR); Won-Ik Kim, Daejeon (KR); Sung Kyung Kim, Daejeon (KR); Namgi Kim, Gyeonggi-do (KR)

(73) Assignee: ELECTRONICS AND TELECOMMUNICATIONS RESEARCH INSTITUTE, Daejeon (KR)

(21) Appl. No.: 13/382,525

(22) PCT Filed: Jul. 6, 2010
(86) PCT No.: PCT/KR2010/004408

§ 371 Date: Jan. 5, 2012

(30) Foreign Application Priority Data
Jul. 6, 2009 (KR) 10-2009-0061330
Jul. 6, 2010 (KR) 10-2010-0065096

(51) Int. Cl. H04W 36/00

(52) U.S. Cl. 370/331

(57) ABSTRACT

Provided is a method for requesting neighbor base station information by user equipment in a wireless communication system. The method includes: searching neighbor base stations targeted for a handover; transmitting a list request message including preamble information about a neighbor base station searched by the user equipment among the neighbor base stations and a neighbor base station list request indicator indicating a request for information about the neighbor base station to a serving base station; and receiving a list response message including an identification information and system information of the neighbor base station from the serving base station.

### TECHNICAL FIELD

The present invention relates to wireless communications, and more particularly, to a method and apparatus for transmission of neighbor base station information, performed by a macro base station in a wireless communication system.

### BACKGROUND ART

The institute of electrical and electronics engineers (IEEE) 802.16e standard was adopted in 2007 as the sixth standard for international mobile telecommunication (IMT)-2000 in the name of ‘wireless metropolitan area network (WMAN)-orthogonal frequency division multiple access (OFDMA) time division duplexing (TDD)’ by the ITU-radio communication sector (ITU-R) which is one of sectors of the international telecommunication union (ITU). An IMT-advanced system has been prepared by the ITU-R as a next generation (i.e., 4^{th} generation, 4G) mobile communication standard following the IMT-2000. In late 2006, it was determined by the IEEE 802.16 working group (WG) to conduct the 802.16m project for the purpose of creating an amendment standard of the existing IEEE 802.16e as a standard for the IMT-advanced system. As can be seen in the purpose above, the 802.16m standard has two aspects, that is, continuity from the past (i.e., the amendment of the existing 802.16e standard) and continuity to the future (i.e., the standard for the next generation IMT-advanced system). Therefore, the 802.16m standard needs to satisfy all requirements for the IMT-advanced system while maintaining compatibility with a mobile WiMAX system conforming to the 802.16e standard.

In the 802.16m system, femto-cell technology may be used, and researches thereof have recently been in progress. A femto cell is a base station having low power, which can be installed by a user. A femto base station supporting the femto cell uses the same frequency as or a different frequency from a macro base station, and basically employs public Internet for a wired Internet network as a backbone network. Access to the femto cell may be allowed to only a closed group of users or an open group of users. Also, the femto cell needs to support a contiguous handover between the macro cells or other femto cells. The location information of the femto base station has to be grasped, and there should be no problem of operation even though a plurality of femto cells is densely installed.

Also, the femto cell supports a low duty operation (LDO) mode to decrease interference with neighbor cells. The femto cell, which enters the LDO mode, alternates between an availability interval (AI) and an unavailability interval (UAI). Like a general macro base station, the femto base station entering the AI can perform synchronization and signal transmission for paging or ranging, and transmit information between user equipment (UE) and the base station for data transmission of the UE. On the other hand, the femto base station entering the UAI does not transmit and receive any information with the UE through an air interface to minimize the interference. The AI and the UAI may be set differently according to conditions of the base station and according to the femto base stations.

Before the introduction of the femto cell, a conventional wireless communication system has broadcasted information about neighbor base stations from each macro base station to all UE to support a handover between the macro cells. This may be performed by an NBR-ADV message of an IEEE 802.16 system. The information contained in a relevant message includes information about a base station identifier (BSID) of each neighbor base station, information about uplink (UL)/downlink (DL) parameters, etc., which are provided for reducing time taken in selecting a proper target base station and synchronization with and a reentry into the proper target base station. However, in general, the plurality of femto cells is installed with high density within the macro cell, and it is therefore inefficient that the macro base station broadcasts information about the neighboring femto base station to the UE. On the contrary, if the macro base station does not provide any information about the neighboring femto base station to the UE, it may take long time for the UE to recognize the neighboring femto base station and perform search procedures for acquiring relevant information.

Accordingly, there is a need of a new method for making the macro base station efficiently provide information about the neighbor base station to the UE.

### SUMMARY OF INVENTION

### Technical Problem

The present invention provides a method and apparatus for transmission of neighbor base station information, performed by a macro base station in a wireless communication system.

### Technical Solution

In an aspect of the invention, there is provided a method for requesting neighbor base station information by user equipment in a wireless communication system, the method including: searching neighbor base stations targeted for a handover; transmitting a list request message including preamble information about a neighbor base station searched by the user equipment among the neighbor base stations and a neighbor base station list request indicator indicating a request for information about the neighbor base station to a serving base station; and receiving a list response message including an identification information and system information of the neighbor base station from the serving base station.

The list response message may be a unicast message transmitted to the user equipment through a dedicated channel.

The list request message may be a Medium Access Control (MAC) message for requesting the serving base station to scan the neighbor base station.

The list request message may be a MAC message for requesting the identification information and the system information of the neighbor base station.

The list request message may be a MAC message for reporting a result from searching the neighbor base stations to the serving base station.

The serving base station may be a macro base station.

The method may further include receiving a broadcast message including the kind, frequency assignment and location information of the neighbor base stations from the serving base stations before searching the neighbor base stations.

The user equipment may perform a handover to one of the neighbor base stations.

In another aspect of the invention, there is provided a method for transmitting neighbor base station information by a serving base station in a wireless communication system, the method including: receiving a list request message including preamble information about a neighbor base station searched by user equipment among the neighbor base stations around the serving station and a neighbor base station list request indicator indicating a request for information about the neighbor base station from the user equipment; and transmitting a list response message including an identification information and system information of the neighbor base station to the user equipment.

### Advantageous Effects

When the UE performs a handover (HO) from a macro cell to a femto cell, it is possible to efficiently transmit information about the neighboring base station for the HO.

### DESCRIPTION OF DRAWINGS

FIG. 1 shows an exemplary embodiment of a proposed transmission method for neighbor base station information.

FIG. 2 shows another exemplary embodiment of a proposed transmission method for neighbor base station information.

FIG. 3 shows another exemplary embodiment of a proposed transmission method for neighbor base station information.

FIG. 4 shows an exemplary embodiment of a proposed handover method.

FIG. 5 shows a block diagram showing a base station according to an exemplary embodiment of the present invention.

### MODE FOR INVENTION

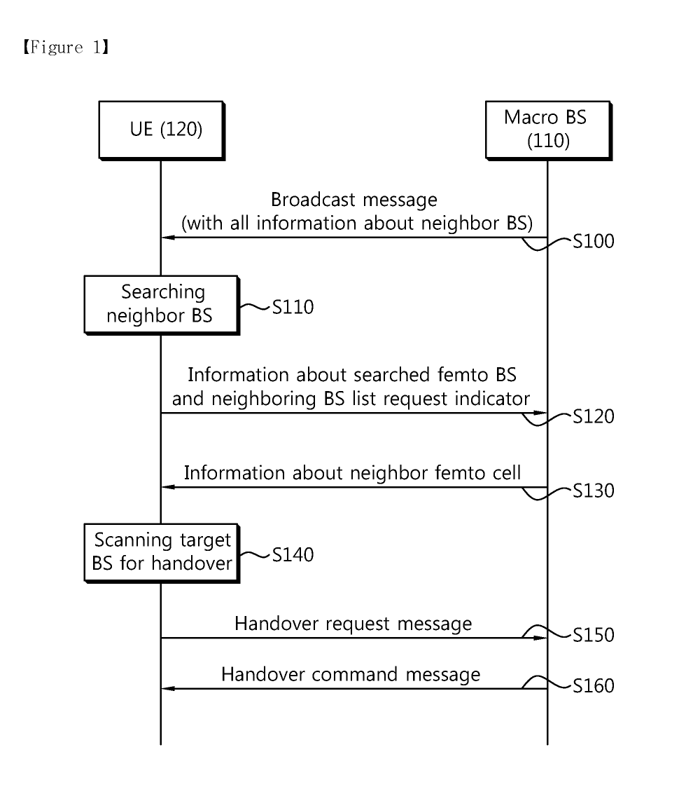

FIG. 1 shows an exemplary embodiment of a proposed transmission method for neighbor base station information.

At a step S100, a macro base station (BS) 110 that is a serving base station providing service to user equipment (UE) generates a broadcast message containing a plurality of fragment broadcast messages, and transmits it to a plurality of UE. Here, a broadcast method may be used in the transmission to the plurality of UE.

Each of the fragment broadcast messages may have information about different neighbor base station from one another according to the kinds of the neighbor base station, the location of the neighbor base station or the frequency assignment of the neighbor base station.

The information about the neighbor base station may include the same level of information as the macro base station 110. If the neighbor base station is a femto base station, the broadcast message may includes a parameter related to information about whether or not the relevant femto base station operates in an low duty operation (LDO) mode and a pattern that alternating between an availability interval (AI) and an unavailability interval (UAI) in the case of the LDO mode. Since each fragment broadcast message can be classified depending on the kinds of the neighbor base station, the fragment broadcast messages may be generated with respect to the kind of each base station if the kind of the neighbor base station is classified into a macro base station, a micro base station, a relay station, a femto base station, etc. Thus, in the case that the neighbor base station includes both the macro base station and the femto base station, the neighbor base station information about the macro base station and the neighbor base station information about the femto base station may be included in different fragment broadcast messages from each other within the broadcast message. Also, each fragment broadcast message may be classified with respect to the frequency assignment or the location of the neighbor base station. For example, although the neighbor base stations are all the femto base stations of the same kind, the neighbor base station information may be included in the different fragment broadcast messages from each other within the broadcast message in accordance with the frequency assignment or the location information.

Meanwhile, the broadcast message may be periodically transmitted by the macro base station. The plurality of fragment broadcast messages included in the broadcast message may be transmitted in certain order. That is, all the fragment broadcast messages included in the broadcast message are once transmitted within a certain cycle, and thus the transmission cycle of the broadcast message may be set up. Alternatively, a cycle may be set according to respective the fragment broadcast messages, and thus the respective fragment broadcast messages may be transmitted to UE 120.

The UE 120 receives at least one fragment broadcast message among the plurality of fragment broadcast messages transmitted from the macro base station. The at least one fragment broadcast message may include index information of the relevant fragment broadcast message in the broadcast message. Also, the at least one fragment broadcast message may include information about the number of fragment broadcast messages included in the broadcast message. Therefore, even though the UE 120 fails in receiving the broadcast message due to a channel condition when receiving the broadcast message, the UE 120 can perform a handover to a corresponding neighbor base station in the case that the fragment broadcast message is received with regard to a necessary neighbor base station. Also, if the number of fragment broadcast message is 1, the index information of the fragment broadcast message may be an identifier (ID) of the corresponding neighbor base station.

The UE 120, which receives at least one fragment broadcast message included in the broadcast message in the step S110, searches the neighbor base stations on the basis of information included in the fragment broadcast message.

The UE 120 can search the neighbor base station in a frequency where the macro base station 110 operates. If failing in searching the neighbor base station in the corresponding frequency or being in need of searching the neighbor base station through another frequency band, the UE 120 may transmit a scanning request message to request scanning for a different certain frequency to the macro base station 110. The macro base station 110 can transmit a scanning response message in response to a scanning request of the UE 120, and thus the UE 120 can search the neighbor base station again on the basis of the information included in the scanning response message. Frequencies for searching the neighbor base station included in the scanning response message may be selected on the basis of information provided in the broadcast message.

As opposed to the above description, the UE 120 may not receive the fragment broadcast message included in the broadcast message. In this case, the step of transmitting the scanning request message and receiving the scanning response message is performed like the case of failing in searching the neighbor base station or being in need of the search for other frequency bands. Also, the selection of the searching frequency may be determined on the basis of information provided in the broadcast message.

The scanning request message may include information about whether the fragment broadcast message is received or not. In this case, the scanning request message may include index information of the received fragment broadcast message. If the broadcast message is constituted one fragment broadcast message, the ID of the neighbor base station corresponding to the fragment broadcast message may be used as the index information of the fragment broadcast message.

Even when the scanning request/response message is transmitted and received, procedure following the search of the neighbor base station is the same as general procedure to be described below according to this exemplary embodiment.

At a step S120, the UE 120 transmits searched femto base station information and a neighbor base station list request indicator to the macro base station 110. Here, the neighbor base station list request indicator means that the UE 120 requests information about a list of the neighbor base station existing around a searched femto base station.

The searched femto base station information and the neighbor base station list request indicator may be transmitted by the UE 120 as being included a neighbor base station information request message AAI_NBR-REQ transmitted for requesting information about the neighbor base station, a scanning request message AAI_SCN-REQ making a request to a serving cell for scanning the neighbor base station, and a scanning report message AAI_SCN-REP transmitted for reporting a scanning result to the serving cell. Also, in the case where the searched femto base station information and the neighbor base station list request indicator are transmitted as being included in the foregoing messages, information about whether the broadcast message is partially or fully received may be included in the message.

The searched femto base station information to be transmitted may include information about the kind of the requested neighbor base station, information about the searched femto base station identifier (preamble or BSID), information about the frequency assignment (FA) of the searched femto base station, quality of a downlink signal received from the searched femto base station, etc. The information about the kinds of the neighbor base station may be represented in the form of a bitmap showing the type of the neighbor base station or type information.

At a step S130, the macro base station 110 transmits information about the femto cell around the UE 120 in response to the searched femto base station information and the neighbor base station list request indicator transmitted from the UE 120. In this case, the information about the neighbor femto cell may include a list and a BSID of the neighbor femto base stations existing in the neighbor femto cells, and may include system information of the relevant femto base station. Also, when the neighbor base station operates in the LDO mode, the information about the neighbor femto cell may include an LDO parameter of the corresponding base station.

The neighbor femto cell information may be transmitted as being included in the broadcast message, and may be transmitted as being included in the fragment broadcast message as necessary. While the broadcast message in the step S100 is transmitted by the broadcast method, the broadcast message in this step is transmitted to the UE 120 by a unicast method. Also, since this message is a message configured separately from the broadcast message of the step S100, it does not include the index information indicating a certain fragment broadcast message or the like.

The list of the neighbor femto base stations in the neighbor femto cell information to be provided to the UE 120 may be determined on the basis of the location information of the UE 120. The location information of the UE 120 may be acquired through geographical information of the femto cell base stations that has already been recognized by the macro base station if the information (e.g., the information about the kind of requested neighboring base station, the ID (preamble or BSID) of the searched femto base station, the information about the frequency assignment of the searched femto base station, and the quality of a downlink signal received from the searched femto base station, etc.) about the femto base station searched by the UE 120 is given to the macro base station 110 when the neighbor femto base station requests the list.

At a step S140, the UE 120 scans the femto base station proper to the handover among the neighbor femto base stations on the basis of the received neighbor femto cell information.

At a step S150, the UE 120 transmits a handover request message, which requests the handover to the corresponding femto base station, to the macro base station 110 when the proper femto base station is scanned.

At a step S160, the UE 120 receives a handover command message corresponding to the handover request message from the macro base station 110. The UE 120 that receives the handover command message performs the handover to the corresponding femto base station.

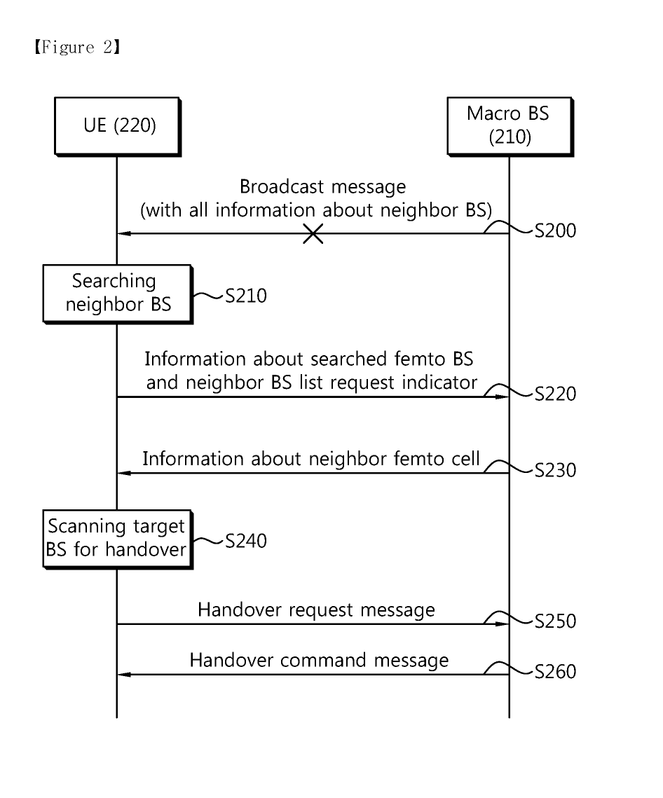

FIG. 2 shows another exemplary embodiment of a proposed transmission method for neighbor base station information.

At a step S200, the macro base station 210 generates a broadcast message including a plurality of fragment broadcast message and transmits the broadcast message to a plurality of UE. This is the same as the step S100 of FIG. 1, and therefore repetitive descriptions thereof will be avoided.

However, the UE 220 may not receive the broadcast message according to channel conditions. Also, the UE 220 may not receive the fragment broadcast messages including information about the searched neighbor base station yet. In this case, the UE 220 may request information about the neighbor base station to the macro base station 210. At this time, the UE 220 can directly search the neighbor base station (S210) and provide the information to the macro base station 120.

The UE 220 transmits searched femto base station information and a neighbor base station list request indicator to the macro base station 210 (S220). At a step S230, the macro base station 210 transmits information about the femto cell around the UE 220 in response to the searched femto base station information and the neighbor base station list request indicator transmitted from the UE 220. At a step S240, the UE 220 scans the femto base station proper to the handover among the neighbor femto base stations on the basis of the received neighbor femto cell information. At a step S250, the UE 220 transmits a handover request message, which requests the handover to the corresponding femto base station, to the macro base station 210 when the proper femto base station is scanned. At a step S260, the UE 220 receives a handover command message corresponding to the handover request message from the macro base station 210. The UE 220 that receives the handover command message performs the handover to the corresponding femto base station. The foregoing steps S220 to S260 in this exemplary embodiment are the same as the steps S110 to S160 described with reference to FIG. 1, and thus repetitive descriptions thereof will be avoided.

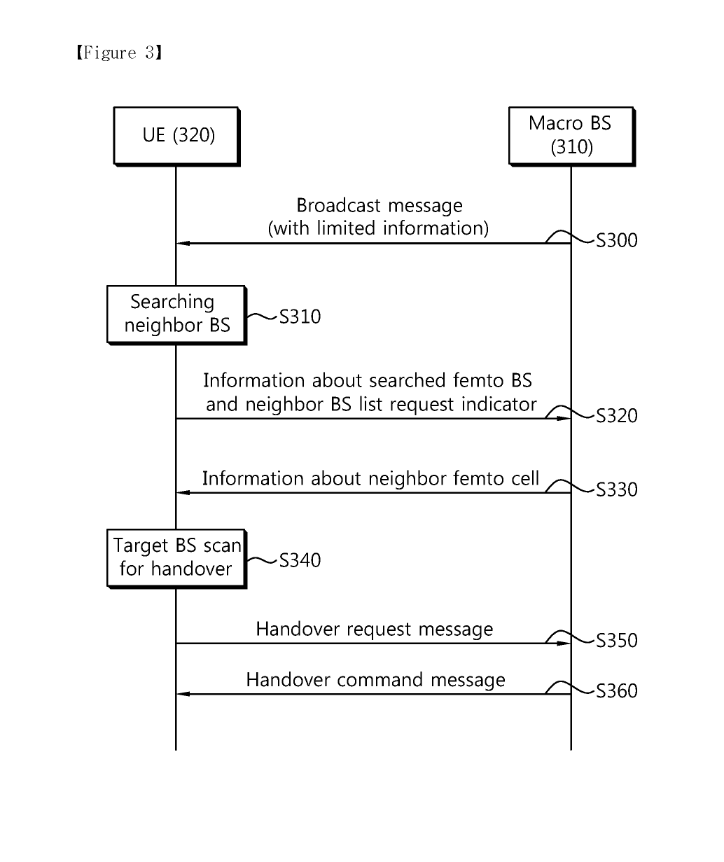

FIG. 3 shows another exemplary embodiment of a proposed transmission method for neighboring base station information.

At a step S300, the macro base station 310 generates a broadcast message including a plurality of fragment broadcast message and transmits the broadcast message to a plurality of UE.

Each of the fragment broadcast messages may have information about different neighbor base station from one another according to the kinds of the neighbor base station, the location of the neighbor base station or the frequency assignment of the neighbor base station.

As opposed to the exemplary embodiment of FIG. 1, the neighbor base station information includes limited information such as presence of the neighbor base station within the frequency assignment for the macro base station 310 and/or the number of neighboring base stations, etc. As a criterion for generating the fragment broadcast messages, there may be used the kind of neighbor base station, the frequency assignment of the neighbor base station or the location information. Meanwhile, the broadcast message may be periodically transmitted by the macro base station. The plurality of fragment broadcast messages included in the broadcast message may be transmitted in certain order.

At a step S310, the UE 320 receives at least one fragment broadcast message included in the broadcast message and thus searches the neighbor base station.

At a step S320, the UE 320 transmits searched femto base station information and a neighbor base station list request indicator to the macro base station 310. Here, the neighbor base station list request indicator means that the UE 320 requests information about a list of the neighbor base station existing around a searched femto base station.

The searched femto base station information to be transmitted may include information about the kind of the requested neighbor base station, information about the searched femto base station identifier (preamble or BSID), information about the frequency assignment of the searched femto base station, quality of a downlink signal received from the searched femto base station, etc. The information about the kinds of the neighbor base station may be represented in the form of a bitmap showing the type of the neighbor base station or type information.

The searched femto base station information and the neighbor base station list request indicator may be transmitted by the UE 320 as being included a neighbor base station information request message AAI_NBR-REQ, a scanning request message AAI_SCN-REQ, and a scanning report message AAI_SCN-REP. Also, in the case where the searched femto base station information and the neighbor base station list request indicator are transmitted as being included in the foregoing messages, information about whether the broadcast message is partially or fully received may be included in the message.

At a step S330, the macro base station 310 transmits information about the femto cell around the UE 320 in response to the searched femto base station information and the neighbor base station list request indicator transmitted from the UE 320. However, the transmission method for the neighbor femto cell information may be varied depending on message types transmitted from the UE 320 to the macro base station 310 in the step S320.

If the message transmitted from the UE 320 is the neighbor base station information request message AAI_NBR-REQ, the macro base station 310 first ascertains the type of the neighbor base station requested by the UE 320 and transmits the neighbor femto cell information containing optimized information about the neighbor base station around the UE 320. At this time, the neighbor femto cell information may be transmitted as being included in a neighbor base station information response message AAI_NBR-RSP.

If the message transmitted from the UE 320 is the scanning request message AAI_SCN-REQ, it is first ascertained whether the neighbor base station list request indicator exists in the scanning request message. If there is the indicator, it is possible to transmit a scanning response message AAI_NBR-RSP for regarding the neighbor base station corresponding to the type of a requested neighbor base station as a scanning target base station.

If the message transmitted from the UE 320 is the scanning report message AAI_SCN-REP, it is possible to instantly give a command for a handover to the searched femto base station on the basis of the report from the UE 320. In this case, the neighbor femto cell information is not provided. However, the neighbor femto cell information may be transmitted if there exists the neighbor base station list request indicator. The neighbor femto cell information may be transmitted as being included in the broadcast message or the fragment broadcast message. While the broadcast message in the step S300 is transmitted by the broadcast method, the broadcast message in this step is transmitted to the UE 320 by a unicast method.

If the neighbor femto cell information is transmitted in the step S330, it may include a list and a BSID of the neighbor femto base stations existing in the neighbor femto cells, and may include system information of the relevant femto base station. Also, when the neighbor base station operates in the LDO mode, the neighbor femto cell information may include an LDO parameter of the corresponding base station.

The list of the neighbor femto base stations of the neighbor femto cells to be provided to the UE 320 may be determined on the basis of the location information of the UE 320. The location information of the UE 320 may be acquired through geographical information of the femto cell base stations that has already been recognized by the macro base station if the information (e.g., the information about the kind of requested neighbor base station, the ID (preamble or BSID) of the searched femto base station, the information about the frequency assignment (FA) of the searched femto base station, and the quality of a downlink signal received from the searched femto base station, etc.) about the femto base station searched by the UE 320 is given to the macro base station 310 when the neighbor femto base station requests the list.

At a step S340, the UE 320 scans the femto base station proper to the handover among the neighbor base stations on the basis of the received neighbor femto cell information.

At a step S350, the UE 320 transmits a handover request message, which requests the handover to the corresponding femto base station, to the macro base station 310 when the proper femto base station is scanned.

At a step S360, the UE 320 receives a handover command message corresponding to the handover request message from the macro base station 310. The UE 320 that receives the handover command message performs the handover to the corresponding femto base station.

In the exemplary embodiments described above with reference to FIGS. 1 through 3, if the femto base station searched in the steps S110, S210, S310 where the UE searches the neighboring base station is included in a closed subscriber group (CSG) which only a limited user is allowed to access, and the request UE belongs to the corresponding group, the UE can change the serving base station into the corresponding searched femto base station through a handover procedure and receive the neighbor femto cell information from the corresponding searched femto base station used as the serving base station. On the other hand, if the searched femto base station is included in an open subscriber group (OSG) having no limitation to the access of the UE, it is possible to request information about the neighbor base station through the message containing the information about the searched femto base station and the neighbor base station list request indicator. The serving base station can ascertain a request for the information about the neighbor base station through the presence of the neighbor base station list request indicator, and provide the information about the neighbor femto cell to the UE. The information about the neighbor femto cell may include information given in the foregoing exemplary embodiments of FIGS. 1 to 3.

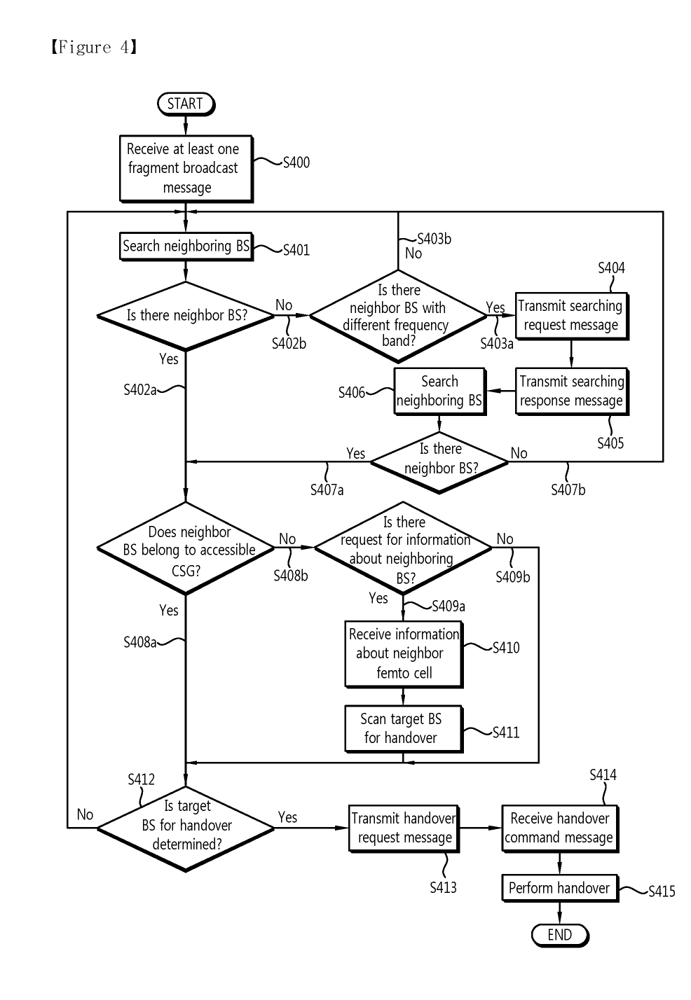

FIG. 4 shows an exemplary embodiment of a proposed handover method.

At a step S400, the UE receives at least one fragment broadcast message included in the broadcast message from the macro base station. The at least one fragment broadcast message includes information about the neighbor base station. Also, each fragment broadcast message included in the broadcast message may include information about the neighbor base stations different from one another according to the kind of the neighbor base station, the location of the neighbor base station, or the frequency assignment for the neighbor base station.

At a step S401, the UE searches the neighbor base station on the basis of the information included in the fragment broadcast message.

As a result of searching, if the neighbor base station (402a) exists, a step for determining whether the corresponding searched femto base station belongs to the CSG where only the limited UE can access and whether the access is possible is performed (S408).

As a result of searching, if the neighbor femto base station does not exist (S402b) and there is a neighbor base station in a frequency band different from the frequency assignment where the macro base station operates (S403a), the UE transmits a searching request message to the macro base station at a step S404 and transmits the scanning request message for requesting the neighbor base station having a different frequency band to be scanned (S404). Then, the UE receives the scanning response message in response to the scanning request (S405), and may search a neighbor base station again on the basis of the information included in the scanning response message (S406). In the case that the neighbor base station exists, the UE makes a decision whether the corresponding searched femto base station is a femto base station belonging to the accessible CSG (S408). If there is no neighbor base station, the UE returns to the step for searching a neighbor base station that uses the frequency of the macro base station (S407b).

If the searched femto base station is a femto base station belonging to the accessible CSG and it is accessible (S408a), a target base station for the handover is determined (S412).

If the searched femto base station is not the femto base station belonging to the accessible CSG (S408b) and the UE transmits a message including an indicator for requesting a list of the neighbor base stations to the macro base station, the UE receives information about the neighbor femto cell from the macro base station (S410) and scans a proper target base station for the handover (S411).

When the UE transmits the message including the indicator for requesting the list of the neighbor base stations, the information about the searched femto base station and about whether the broadcast message is partially or fully received may be additionally included in the message.

The information about the searched femto base station to be transmitted may include information about the kind of the requested neighbor base station, information about the searched femto base station identifier (preamble or BSID), information about the frequency assignment (FA) of the searched femto base station, quality of a downlink signal received from the searched femto base station, etc. The information about the kinds of the neighbor base station may be represented in the form of a bitmap showing the type of the neighbor base station or information by types.

The information about the neighbor femto cell may include a list and a BSID of the neighbor femto base stations existing in the neighbor femto cells, and may include system information of the relevant femto base station. Also, when the neighbor base station operates in the LDO mode, the information about the neighbor femto cell may include an LDO parameter of the corresponding base station.

The neighbor femto cell information may be transmitted as being included in the broadcast message and the fragment broadcast message. While the broadcast message in the step S400 is transmitted by the broadcast method, the broadcast message in this step is transmitted to the UE by a unicast method. Also, since this message is a message configured separately from the broadcast message of the step S400, it does not include the index information or the like indicating a certain fragment broadcast message of S400.

In the meantime, if the UE does not request a list of the neighbor base station, a target base station for the handover is determined (S412).

After determining the target base station for the handover, the UE transmits the handover request message for requesting the handover to the corresponding femto base station to the macro base station (S413), and receives the handover command message corresponding to the handover request message from the macro base station (S415). Then, the UE performs the handover to the corresponding femto base station (S415).

Various exemplary embodiments of the present invention were described above with reference to FIGS. 1 to 4. In the foregoing descriptions, the macro base station 110, 210, 310 were regarded as the serving base station that provided service to the UE, but not limited thereto. Alternatively, the femto base station may be used as the serving base station. Also, the UE 120, 220, 320 may search (S110, S210, S310) or scan (S140, S240, S340) not only the neighbor femto base station but also the neighbor macro base station or the like as the target base station for the handover.

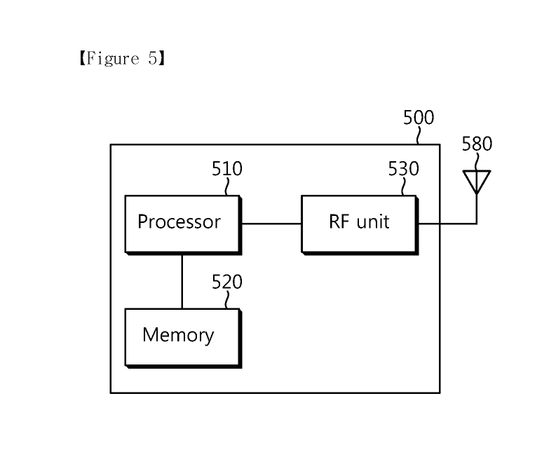

FIG. 5 shows a block diagram showing a base station according to an exemplary embodiment of the present invention. A base station 500 includes a processor 510, a memory 520, and a radio frequency (RF) unit 530.

Referring to FIG. 5, the processor 510 implements a proposed function, process and/or method. The processor 510 generates a broadcast message including a plurality of fragment broadcast messages, and transmits the broadcast message to a plurality of UE, in which each of the fragment broadcast messages may have information about different neighbor base station from one another according to the kinds of the neighbor base station, the location of the neighbor base station or the frequency assignment of the neighbor base station. Layers of a wireless interface protocol may be fulfilled by the processor 510. The memory 520 is connected to the processor 510, and stores diverse information for operating the processor 510. The RF unit 530 is connected to the processor 510 and transmits and/or receives a wireless signal.

The processor 510 may include application specific integrated circuit (ASIC), other chipsets, a logic circuit and/or a data processor. The memory 520 may include a read-only memory (ROM), a random access memory (RAM), a flash memory, a memory card, a storage medium and/or other storage devices. The RF unit 530 may include a baseband circuit for processing a wireless signal. In the case that the embodiments are achieved by software, the foregoing methods may be achieved by a module (procedure, function, etc.) that performs the above functions. The module is stored in the memory 520, and executed by the processor 510. The memory 520 may be provided inside or outside the processor 510, and connected to the processor 510 by well-known various means.

All the foregoing functions may be implemented by a processor such as a microprocessor, a controller, a microcontroller, an application specific integrated circuit (ASIC) or the like based on software or program coded to perform the above functions. The design, development and implementation of the code may be apparent to those skilled in the art on the basis of the description of the present invention.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A method for requesting neighbor base station information by user equipment in a wireless communication system, the method including:
searching neighbor base stations targeted for a handover;
transmitting a list request message including preamble information about a neighbor base station searched by the user equipment among the neighbor base stations and a neighbor base station list request indicator indicating a request for information about the neighbor base station to a serving base station; and
receiving a list response message including an identification information and system information of the neighbor base station from the serving base station.

2. The method of claim 1, wherein the list response message is a unicast message transmitted to the user equipment through a dedicated channel.

3. The method of claim 1, wherein the list request message is a Medium Access Control (MAC) message for requesting the serving base station to scan the neighbor base station.

4. The method of claim 1, wherein the list request message is a MAC message for requesting the identification information and the system information of the neighbor base station.

5. The method of claim 1, wherein the list request message is a MAC message for reporting a result from searching the neighbor base stations to the serving base station.

6. The method of claim 1, wherein the serving base station is a macro base station.

7. The method of claim 1, further including receiving a broadcast message including the kind, frequency assignment and location information of the neighbor base stations from the serving base stations before searching the neighbor base stations.

8. The method of claim 1, wherein the user equipment performs a handover to one of the neighbor base stations.

9. A method for transmitting neighbor base station information by a serving base station in a wireless communication system, the method including:
receiving a list request message including preamble information about a neighbor base station searched by user equipment among the neighbor base stations around the serving station and a neighbor base station list request indicator indicating a request for information about the neighbor base station from the user equipment; and
transmitting a list response message including an identification information and system information of the neighbor base station to the user equipment.

10. The method of claim 9, wherein the list request message further includes information about a type of the neighbor base station for the request.

11. The method of claim 9, wherein the list request message further includes information about a frequency assignment of the searched neighbor base station.

12. The method of claim 9, wherein the list request message further includes information about a downlink signal quality of the searched neighbor base station.

13. The method of claim 1, wherein the list request message further includes information about a type of the neighbor base station for the request.

14. The method of claim 1, wherein the list request message further includes information about a frequency assignment of the searched neighbor base station.

15. The method of claim 1, wherein the list request message further includes information about a downlink signal quality of the searched neighbor base station.
